(19) United States
(12) Patent Application Publication
(10) Pub. No.: US 2018/0025044 A1
(43) Pub. Date: Jan. 25, 2018

(54) UNMANNED VEHICLE DATA CORRELATION, ROUTING, AND REPORTING

(71) Applicant: Drone Comply International, Inc., Silver Spring, MD (US)

(72) Inventors: David W. Hostetter, Kirkland, WA (US); Alan R. Sultan, Silver Spring, MD (US)

(21) Appl. No.: 15/215,030

(22) Filed: Jul. 20, 2016

(51) Int. Cl. G06F 17/30; B64C 39/02

(52) U.S. Cl. CPC G06F 17/30371; B64C 39/024; H04W 4/023

(57) ABSTRACT

Systems, devices, and techniques are generally described to process unmanned vehicle data. First unmanned vehicle data related to a particular unmanned vehicle may be received from a first computing device. Second unmanned vehicle data related to the particular unmanned vehicle may be received from a second computing device. A determination may be made that the first unmanned vehicle data and the second unmanned vehicle data relate to the particular unmanned vehicle. A parameter from a governmental entity may be identified. The parameter may define an operating limitation for unmanned vehicles. The first unmanned vehicle data and/or the second unmanned vehicle data may be compared to the parameter. A determination may be made that the particular unmanned vehicle has operated in violation of the operating limitation.

### FIELD

This application relates generally to gathering, routing, and correlating data related to unmanned vehicles.

### BACKGROUND

The number of unmanned vehicles being used for both commercial and non-commercial applications continues to increase as the cost of unmanned vehicle technology becomes cheaper. This upward trajectory in unmanned vehicle ownership and use is expected to continue unabated with commercial and consumer unmanned vehicle usage expected to become commonplace in the near future. It is expected that unmanned vehicles will soon be a part of everyday life. Concomitant with the rise in the number of unmanned vehicles is the increase of privacy and safety concerns on behalf of individual citizens, private industries, and regulatory bodies. Federal, State, and local governments are attempting to address these concerns by instituting laws and other regulations. For example, the United States Federal Aviation Administration (“FAA”) has instituted registration requirements (among other regulatory requirements) for all unmanned aircraft over 0.55 lbs. Aviation incident investigation has traditionally been handled at the national level, which has worked with the limited number of planes in the air, but with hundreds of thousands or even millions of additional unmanned vehicles flying or otherwise traversing the world, regulation and enforcement may become an increasingly local operation. Additionally, increased interplay of local, State, and Federal agencies may be necessary to institute and enforce unmanned vehicle regulations. For example, commercial insurance for unmanned vehicle ownership and operation may be governed at the State level while the FAA and Federal Communication Commission (“FCC”) may regulate unmanned vehicles at the national level. Various civil and criminal penalties may result from owning and/or operating a unmanned vehicle in violation of federal, state, and/or local laws.

### SUMMARY

In accordance with embodiments of the present invention, a computer-implemented method of processing unmanned vehicle data is provided. The method comprises: receiving first unmanned vehicle data related to a particular unmanned vehicle from a first computing device and receiving second unmanned vehicle data related to the particular unmanned vehicle from a second computing device. In some embodiments, the method may further comprise determining that the first unmanned vehicle data and the second unmanned vehicle data relate to the particular unmanned vehicle. In some further embodiments, the method may include identifying a parameter from a governmental entity, wherein the parameter defines an operating limitation for unmanned vehicles. The method may further comprise comparing at least one of the first unmanned vehicle data and the second unmanned vehicle data to the parameter. The method may further comprise determining that the particular unmanned vehicle has operated in violation of the operating limitation.

In accordance with other embodiments of the present invention, a computing device is provided, comprising: at least one processor and a non-transitory, computer-readable memory configured to be in communication with the at least one processor. In various examples, the at least one processor may be effective to receive first unmanned vehicle data related to an unmanned vehicle from a first computing device. The at least one processor may be further effective to receive second unmanned vehicle data related to the unmanned vehicle from a second computing device. In some examples, the at least one processor may be further effective to determine that the first unmanned vehicle data and the second unmanned vehicle data relate to the unmanned vehicle by correlating first metadata of the first unmanned vehicle data with second metadata of the second unmanned vehicle data. In various examples, the at least one processor may be effective to identify a parameter stored in the computer-readable memory. The parameter may define an operating limitation for unmanned vehicles. In some further examples, the at least one processor may be further effective to compare at least one of the first unmanned vehicle data and the second unmanned vehicle data to the parameter. In some other examples, the at least one processor may be effective to determine that the unmanned vehicle has operated in violation of the operating limitation.

In accordance with embodiments of the present invention, a computer-implemented method to identify an unmanned vehicle is provided. The method comprises receiving location data and time stamp data from a mobile computing device as a part of an unmanned vehicle incident report. The location data may indicate a location. In some examples, the method may further comprise searching a database by using the location data and the time stamp data as a search query to the database. In some other examples, the method may further comprise receiving a first list of reported unmanned vehicle incidents. The reported unmanned vehicle incidents may have occurred within a threshold distance of the location and within a threshold amount of time of the time indicated by the time stamp data. In some other examples, the method may further comprise identifying a second list of one or more unmanned vehicles involved in the first list of reported unmanned vehicle incidents. In various other examples, the method may further include sending the second list of the one or more unmanned vehicles to the mobile computing device or another computing device.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF DRAWINGS

FIG. 1 illustrates an example system for collecting and processing unmanned vehicle data, in accordance with embodiments of the present disclosure.

FIG. 2 illustrates a block diagram of an example unmanned vehicle, in accordance with embodiments of the present disclosure.

FIG. 3A illustrates a home screen of an unmanned vehicle data collection and reporting application, in accordance with various embodiments of the present disclosure.

FIG. 3B illustrates an image and video capture screen of an unmanned vehicle data collection and reporting application, in accordance with various embodiments of the present disclosure.

FIG. 3C illustrates a reporting screen of an unmanned vehicle data collection and reporting application, in accordance with various embodiments of the present disclosure.

FIG. 3D illustrates another reporting screen of an unmanned vehicle data collection and reporting application, illustrating details related to an incident type, in accordance with various embodiments of the present disclosure.

FIG. 3E illustrates a reporting confirmation screen of an unmanned vehicle data collection and reporting application, in accordance with various embodiments of the present disclosure.

FIG. 3F illustrates an unmanned vehicle search screen of an unmanned vehicle data collection and reporting application, in accordance with various embodiments of the present disclosure.

FIG. 3G illustrates an unmanned vehicle search results screen of an unmanned vehicle data collection and reporting application, in accordance with various embodiments of the present disclosure.

FIG. 3H illustrates an unmanned vehicle information screen of an unmanned vehicle data collection and reporting application, in accordance with various embodiments of the present disclosure.

FIG. 3I illustrates a submitted incident status screen of an unmanned vehicle data collection and reporting application, in accordance with various embodiments of the present disclosure.

FIG. 4 depicts a process flow for processing unmanned vehicle data received by unmanned vehicle data service, in accordance with various aspects of the present disclosure.

FIG. 5 depicts an example system for collecting and processing unmanned vehicle data, in accordance with embodiments of the present disclosure.

### DETAILED DESCRIPTION

Systems and methods are provided for a cloud-based unmanned vehicle data service. Unmanned vehicles may sometimes be referred to as “drones”. Information regarding unmanned vehicles may be collected and provided to a networked cloud storage and routing repository. For example, unmanned vehicle data may be captured by individuals via a mobile device application effective to receive and/or capture data related to unmanned vehicle movements (e.g., flight). In some examples, the mobile device application may receive input through a user interface of the application. Examples of data input via the user interface may include image data captured with a camera of the mobile device or another camera, position data from a GPS sensor of the mobile device, information manually input by a user of the mobile device, and unmanned vehicle position and/or identification data transmitted from the unmanned vehicle and received by a sensor of the mobile device, to name a few examples. The mobile device application may also serve as an interface between the mobile device user and one or more entities alerted to a particular unmanned vehicle incident reported by the user through the mobile application.

A web service may perform back-end processing on unmanned vehicle data received from various users through the mobile application, directly from operating unmanned vehicles, and/or from various other unmanned vehicle information databases. In various examples, unmanned vehicle data received from the mobile application, from operating unmanned vehicles, and/or from various other unmanned vehicle information databases may be transmitted and received in real time or in batches. For example, the web service may correlate flight path and position data to determine that various pieces of independently collected unmanned vehicle data pertain to the same unmanned vehicle. In addition, the web service may be able to identify the unmanned vehicle and/or a user of the unmanned vehicle by correlating the unmanned vehicle data with an unmanned vehicle registration database. The web service may also aggregate various other types of unmanned vehicle data, such as weather conditions, when correlating and synthesizing unmanned vehicle data and/or unmanned vehicle incident data.

The web service may compare unmanned vehicle data and/or unmanned vehicle incident data to applicable regulations and/or laws. For example, the web service may determine that a particular unmanned vehicle is flying or has flown at an altitude of 467 feet in violation of the 400 feet ceiling mandated by FAA Small Unmanned Aircraft Rule (Part 107). In response, the web service may route the unmanned vehicle data or the relevant portion of unmanned vehicle data to the appropriate governmental entity, such as a regulatory agency or law enforcement body. In some examples, the web service may also append relevant regulations to the data to apprise the governmental entity of the particular portion of a regulation and/or law that is being contravened. In some other examples, the web service may be effective to notify the registered user of the unmanned vehicle regarding the violation. The web service may be further effective to determine a severity of the violation. In the event that the violation is deemed to be an emergency, the web service may send out an alert to various agencies, media outlets, law enforcement bodies, etc.

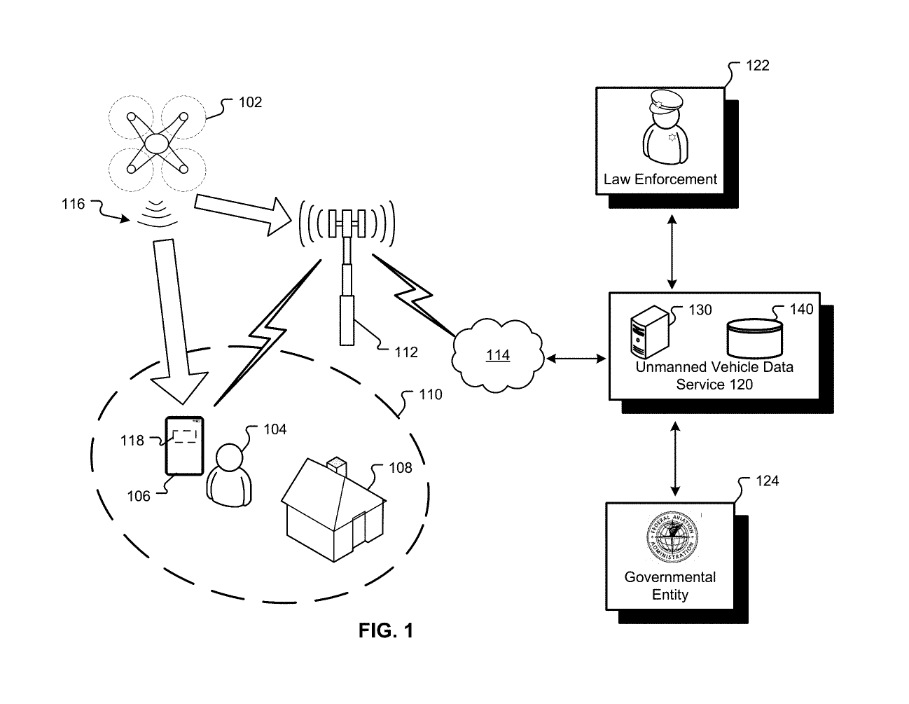

FIG. 1 depicts a system effective to collect and process unmanned vehicle data, in accordance with embodiments of the present invention. As shown in FIG. 1 an unmanned vehicle 102 may be in flight over a privately or publicly owned property 110 and/or a house 108 owned by a user 104. In the illustrated embodiment, the unmanned vehicle 102 is an unmanned aerial vehicle (UAV) or unmanned aircraft system (UAS) capable of powered, unmanned flight, either autonomously or remotely piloted. In other embodiments, the unmanned vehicle 102 may be any type of unmanned vehicle that is capable of movement without an onboard human operator, including, e.g., aerial, land-based, and aquatic vehicles, such as, e.g., a remotely controlled quad-copter, helicopter, all terrain vehicle (ATV), car, an unmanned airplane, boat, submarine, burrowing device, spacecraft, mobile robot, or the like. User 104 may be unaware of the identity of the owner, operator, programmer, pilot and/or pilots of unmanned vehicle 102 and may be concerned about the unmanned vehicle's flight over (or other trespass upon) the user's property 110 and/or house 108. In various examples, the user 104 may be concerned that the unmanned vehicle 102 is surveying the user 104, the property 110, other persons on property 110, and/or house 108. Additionally, user 104 may be concerned about safety risks posed by unmanned vehicle 102. In various examples, unmanned vehicle 102 may cause injury and/or property damage if the unmanned vehicle collides with a person, animal and/or structure. In some other examples, user 104 may become concerned that the unmanned vehicle 102 may be weaponized. In various other examples, user 104 may be concerned that the unmanned vehicle 102 may alarm or disturb people, animals, structures, or equipment on or near property 110. The identity of the pilot of unmanned vehicle 102 may or may not be apparent to user 104. In other embodiments, user 104 may be concerned that unmanned vehicle 102 is engaging in an unauthorized recording of an event, location, individuals, or performance.

User 104 may have access to a computing device 106 that includes a unmanned vehicle data collection and reporting application 118, sometimes referred to herein as user application 118. In various examples, computing device 106 may be a mobile, battery-powered computing device capable of wireless communications, such as, e.g., a smart phone, a tablet computing device, a laptop computing device, or a wearable computing device, or can be a computing device with a wired network connection, such as, e.g., a desktop computing device. As will be described in further detail below, unmanned vehicle data collection and reporting application 118 may be programmed to collect unmanned vehicle data related to nearby unmanned vehicles, such as unmanned vehicle 102. Unmanned vehicle data may include various information related to a particular unmanned vehicle. In some non-exhaustive examples, unmanned vehicle data may include a position data related to the unmanned vehicle. Position data may include coordinates such as longitude and/or latitude of the unmanned vehicle. Such position data may be time stamped so that the user can see the coordinates of the unmanned vehicle at a particular time. Additionally, position data may include an altitude of the unmanned vehicle so that user 104 can see the altitude of the unmanned vehicle at particular points in time.

Unmanned vehicle data may also include other types of information. For example, unmanned vehicle data may include a velocity of the unmanned vehicle, acceleration and/or deceleration of the unmanned vehicle, rates of ascent and/or descent (sometimes referred to as vertical velocity), and/or a heading of the unmanned vehicle. Velocity data, acceleration/deceleration data, rates of ascent/descent, and heading data may likewise be time-stamped. Unmanned vehicle data may further include an identification of the unmanned vehicle and/or an identification of the unmanned vehicle pilot. For example, the unmanned vehicle data may include a model number, model name, serial number, registration number, or other data identifying the particular unmanned vehicle from among other unmanned vehicles. The unmanned vehicle data may include video data captured by the unmanned vehicle. For example, unmanned vehicle data collection and reporting application 118 may in some cases be effective to intercept video signals, audio signals, and/or other signals produced by unmanned vehicle 102, such as signals sent from unmanned vehicle 102 to an owner and/or operator of unmanned vehicle 102. In examples where the unmanned vehicle data is an audio signal, the audio signal may be produced by the unmanned vehicle and/or may be an audio signal captured by the unmanned vehicle. In some examples, the audio signal produced by the unmanned vehicle may be unique to the particular unmanned vehicle or to a class of the particular unmanned vehicle and may be used to identify and/or aid in identifying the unmanned vehicle. In other examples, the unmanned vehicle data may include a name, address, registration ID, pilot ID, and/or other identifying data related to an owner registered to the particular unmanned vehicle 102. In some examples, unmanned vehicle owner identifying data may be anonymized to protect the identity of the unmanned vehicle owner from the public at large. However, the anonymized identity of the unmanned vehicle owner may still be linked to the name of the owner in a unmanned vehicle database accessible by authorized law enforcement and/or regulatory personnel. The unmanned vehicle data may include a flight path of the unmanned vehicle during a particular time period. The flight path may include indications that the unmanned vehicle has traversed one or more geofences and/or property lines. The unmanned vehicle data may include information regarding a class of unmanned vehicles of which the particular unmanned vehicle is a member. For example, the unmanned vehicle may be identified as a unmanned vehicle of a particular weight class, a particular type (e.g., commercial, military, personal, etc.), and/or of a particular affiliation (e.g., a member of a commercial fleet owned and/or operated by a particular company).

Unmanned vehicle data, such as that described above, may be collected by unmanned vehicle data collection and reporting application 118 in various ways. The various mechanisms for collecting unmanned vehicle data are not mutually exclusive and may be used together in combination, separately, or in various subcombinations. In some examples, unmanned vehicle 102 may transmit a signal 116 that includes unmanned vehicle data. Unmanned vehicle data collection and reporting application 118 may be configured to detect and receive signal 116. In some examples, the signal 116 may be a Wi-Fi signal, an infrared signal, a radio frequency signal, or the like. Signal 116 may be a broadcast signal that is mandated by one or more federal, state, and/or local regulations. In some examples, a tower of a carrier network, such as carrier network 112 may receive signal 116 broadcast from unmanned vehicle 102. Carrier network 112 may rebroadcast signal 116 allowing users of unmanned vehicle data collection and reporting application 118 to detect and receive signal 116. In some cases, signal 116 may be received by unmanned vehicle data service 120 through network 114 and/or carrier network 112 without passing through unmanned vehicle data collection and reporting application 118.

In various other examples, unmanned vehicle data, such as that described above, may be collected by computing device 106 in response to computing device detecting signal 116. For example, signal 116 may include limited information that may or may not identify that the signal source is a unmanned vehicle. Unmanned vehicle data collection and reporting application 118 may receive signal 116 and in response may determine GPS coordinates or other location data indicating a location of computing device 106. For example, computing device 106 may determine GPS coordinates of computing device 106 using a GPS module of computing device 106 at the time when signal 116 is received. In various other examples, computing device 106 may determine location information or use other available location indicators in order to generate location data indicating a location of computing device 106 and/or unmanned vehicle 102. For example, computing device 106 may triangulate a location of computing device 106 and/or unmanned vehicle 102 based on the known location of other objects.

In some examples, a user may take a photograph and/or a video of unmanned vehicle 102 using a camera of computing device 106. The photograph and/or video may be geotagged with location information related to the location of unmanned vehicle 102 and/or of computing device 106. The photograph and/or video may be tagged with a time stamp indicating a time and/or date stamp indicating a date. In some examples, the photograph and/or video may include velocity information, acceleration/deceleration information, heading information, flight path information, altitude information, or the like. For example, computing device 106 may use time information and/or location information to determine average velocity, acceleration, heading information, etc.

In some other examples, user 104 may enter unmanned vehicle data such as that described above into unmanned vehicle data collection and reporting application 118. For example, a user may identify a unmanned vehicle sighting including any information about the unmanned vehicle known to user 104. Additionally, user 104 may report any known or suspected violations of unmanned vehicle 102 through unmanned vehicle data collection and reporting application 118. User 104 may also add comments to any data reported by user 104 through an interface of unmanned vehicle data collection and reporting application 118. For example, user 104 may report that unmanned vehicle 102 is flying erratically and at high speeds near children. In another example, user 104 may report that unmanned vehicle 102 is flying at night, without proper safety lights or equipment, and/or out of the line of sight of a pilot of unmanned vehicle 102. Any information considered relevant and/or of importance by user 104 may be reported through an interface of unmanned vehicle data collection and reporting application 118.

Unmanned vehicle data received by unmanned vehicle data collection and reporting application 118 may be transmitted to unmanned vehicle data service 120. Unmanned vehicle data may be sent via carrier network 112 and/or via network 114. In various examples, network 114 may be a local area network, a wide area network, or a public network such as the internet. Unmanned vehicle data service 120 may be a networked routing, storage, and data processing environment including at least one processor 130 and at least one non-transitory, computer readable memory 140. Computer readable memory 140 may comprise any one of many physical media such as magnetic, optical, or semiconductor media. More specific examples of a suitable computer readable media include, but are not limited to, magnetic tapes, magnetic floppy diskettes, magnetic hard drives, memory cards, solid-state drives, USB flash drives, or optical discs. Also, the computer readable medium may be a random access memory (RAM) including, for example, static random access memory (SRAM) and dynamic random access memory (DRAM), or magnetic random access memory (MRAM). In addition, the computer readable medium may be a read-only memory (ROM), a programmable read-only memory (PROM), an erasable programmable read-only memory (EPROM), an electrically erasable programmable read-only memory (EEPROM), or other type of memory device.

Computer readable memory 140 may include various data parsing and routing instructions for processing unmanned vehicle data. Unmanned vehicle data service 120 may be a cloud-based distributed processing and/or storage system employing various internet-of-things (“IoT”) technologies such as IoT data ingestion, Cloud Pub/Sub, Cloud monitoring, cloud logging, and/or Pipeline cloud data flow to appropriate storage sites within the network accessible computer readable memory.

In addition to receiving data from users via unmanned vehicle data collection and reporting application 118, unmanned vehicle data service 120 may be configured in communication with one or more third party unmanned vehicle databases that include unmanned vehicle data such as the unmanned vehicle data described above. Some examples of third party databases include unmanned vehicle registration databases mandated by FAA regulations, 3DR databases, DJI databases, state and local registration databases, and other unmanned vehicle manufacturer and/or unmanned vehicle operator databases. Application programming interfaces specific to each third party database may be employed to access the data stored therein. In at least some instances, unmanned vehicle data transmitted from a unmanned vehicle (such as signal 116 depicted in FIG. 1) is updated multiple times per second allowing a larger data set for correlation, comparison and/or unmanned vehicle identification. User submitted unmanned vehicle data (e.g., a video or photograph of a unmanned vehicle along with a GPS tag) may be compared and correlated with unmanned vehicle data stored in computer readable memory 140, with unmanned vehicle data stored in third party databases such as local weather and wind speed at the time of unmanned vehicle operation, for example.

Each user submission of unmanned vehicle data received by unmanned vehicle data service 120 may be assigned a unique tracking identifier. Metadata included in the unmanned vehicle data (such as velocity information, position information, time stamps, etc.) may be compared to applicable laws and regulations using a regulatory ruleset employed by unmanned vehicle data service 120. Unmanned vehicle data service 120 stores rules and regulations related to unmanned vehicle ownership and operation in various jurisdictions. For example, unmanned vehicle data service 120 may store federal rules (e.g. FAA rules), state rules, and local rules (e.g., municipal unmanned vehicle operation regulations) in computer readable memory 140. Upon receiving a user submission of unmanned vehicle data and assigning a tracking identifier, unmanned vehicle data service 120 may compare the received unmanned vehicle data with the stored rule sets to determine whether or not one or more potential violations exists. For example, if a particular user submission indicates that a unmanned vehicle was being operated at a velocity in excess of the maximum permissible velocity allowed by a particular state regulation, unmanned vehicle data service may determine that the unmanned vehicle has violated the state regulation. Unmanned vehicle data service 120 includes sets of routing and triage rules for routing unmanned vehicle data, including unmanned vehicle violations, to law enforcement agencies 122 and/or other governmental entities 124. The routing rules may explain to which governmental entity to route particular unmanned vehicle data based on the applicable regulations and the reported unmanned vehicle incident. Triage rules may indicate a hierarchy of incident reporting rules and may be based on the perceived severity of a particular unmanned vehicle incident and/or a particular type of unmanned vehicle incident. For example, a public safety risk posed by unmanned vehicle operation to an in-bound passenger plane may take priority over a citizen's unmanned vehicle-related privacy concern. Law enforcement may be apprised of incidents and may provision resources based upon triage rules.

For example, if a municipality has a municipal law prohibiting unmanned vehicle operation within 100 meters of schools and a user submits unmanned vehicle data indicating that a unmanned vehicle was operated over a school building, the municipal government may be alerted, or a designated office or law enforcement official may be alerted, according to the appropriate routing procedure for unmanned vehicle incident data set up by the municipality. As discussed in further detail below, police departments and/or other enforcement or investigative agencies may use alerts and/or databases of unmanned vehicle data service 120 to manage incident investigation and department resources. In such an example, the FAA may not be notified of the incident, as the FAA may not have any regulations implicated by the particular unmanned vehicle incident. Accordingly, unmanned vehicle incidents may be reported to the appropriate parties according to the particular rules, laws, and/or regulations implicated by the nature of the unmanned vehicle incident. Additionally, in some examples, texts, indications, and/or indicators of the particular rules implicated may be provided by unmanned vehicle data service 120 to the appropriate party along with unmanned vehicle data related to the incident. Further, if the identity and/or contact information of the pilot of the unmanned vehicle involved in the potential violation can be determined, the pilot and/or owner may be contacted (e.g. via text, email, through a unmanned vehicle manufacturer application, and/or through an account associated with unmanned vehicle data collection and reporting application 118) and apprised that they may be violating one or more laws or regulations. The particular law or regulations implicated may be provided in whole or in part so that the pilot and/or owner may take remedial action.

In various further examples, unmanned vehicle data service 120 may provide an indication of the severity of a particular unmanned vehicle-related incident when reporting a violation to the appropriate law enforcement agencies 122 and/or governmental entities 124. The indication of the severity of a particular unmanned vehicle-related incident may be related to a degree of risk associated with the particular violation. For example, if there is a large risk of loss of life or injury related to a particular violation (e.g. an unauthorized weaponized unmanned vehicle) unmanned vehicle data service 120 may provide an emergency alert to the appropriate law enforcement agencies 122 and/or governmental entities 124. Additionally, unmanned vehicle data service 120 may send out email or text blasts to pre-determined emergency contacts in the event of a high-risk unmanned vehicle-related incident.

Appropriate parties, such as law enforcement agencies 122 and/or governmental entities 124 may be granted secure access to networked storage of the unmanned vehicle data service 120 (e.g. computer readable memory 140) for investigative purposes and/or for data collection regarding unmanned vehicle operation for particular geographic areas. Tracking tools may be provided for authenticated entities to use in their investigative capacity. In some further examples, unmanned vehicle data service 120 may provide available information to the public, to particular watch-dog or concerned citizens groups, and/or to insurance companies for the purposes of evaluating risk, to name a few examples.

In examples where user 104 submits unmanned vehicle data through unmanned vehicle data collection and reporting application 118, unmanned vehicle data service 120 may notify user 104 of the tracking identifier of the incident upon receipt of the incident. Additionally, unmanned vehicle data service 120 may provide user 104 with status and/or disposition updates regarding the submitted unmanned vehicle incident through interfaces of unmanned vehicle data collection and reporting application 118.

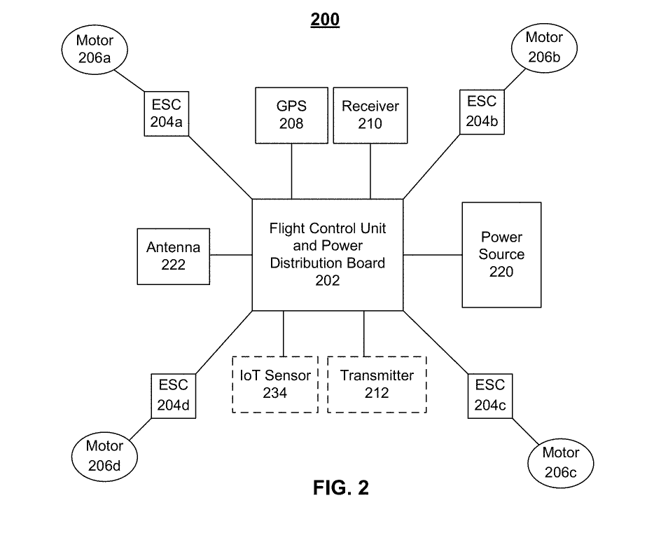

FIG. 2 depicts a block diagram of an example unmanned vehicle 200 in accordance with various embodiments of the present disclosure. Although, the unmanned vehicle depicted in FIG. 2 is an aerial unmanned vehicle, unmanned vehicles as discussed in the disclosure generally may include any unmanned mobile vehicle and/or structure. Unmanned vehicles may be effective to travel through the air, through space, through and/or under water, on land, and/or on some combination of the above. Unmanned vehicles may achieve locomotion in any desired manner and may use a variety of different hardware suitable for a wide variety of particular applications, as desired. A typical quadrotor style unmanned vehicle may include a flight control unit and power distribution board 202. The flight control unit and power distribution board 202 includes an on-board computer that receives and distributes power from power source 220 and controls operation of motors 206a, 206b, 206c, and 206d through control of electronic speed control (“ESC”) units 204a, 204b, 204c, and 204d. ESCs 204a, 204b, 204c, and 204d convert direct current from the flight control unit and power distribution board 202 into alternating current. The alternating current is used to drive the brushless motors 206a, 206b, 206c, and 206d. Motors 206a, 206b, 206c, and 206d are each coupled to a propeller for propulsion of the unmanned vehicle through the air.

Unmanned vehicle 200 may include a GPS unit 208 effective to determine global positioning data. Unmanned vehicle 200 may be effective to modulate data using transmitter 212. Modulated data may be output as a signal via antenna 222. Various modulation techniques, signal types and transmission frequencies may be used according to the desired implementation. Examples of data that may be transmitted from unmanned vehicle 200 includes unmanned vehicle position data, velocity data, heading, global position data, unmanned vehicle and/or pilot identification data, remaining battery power, acceleration data, error messages, etc. Receiver 210 may include a demodulator and may be effective to receive signals from a ground controller unit used to pilot the unmanned vehicle and activate various functionalities (e.g. a camera and/or other peripheral equipment). Unmanned vehicle 200 may include an IoT Sensor 234 effective to detect and communicate with other IoT-enabled devices. IoT Sensor 234 may operate in conjunction with transmitter 212, flight control unit and distribution board 202, and/or receiver 210 in order to communicate with other devices.

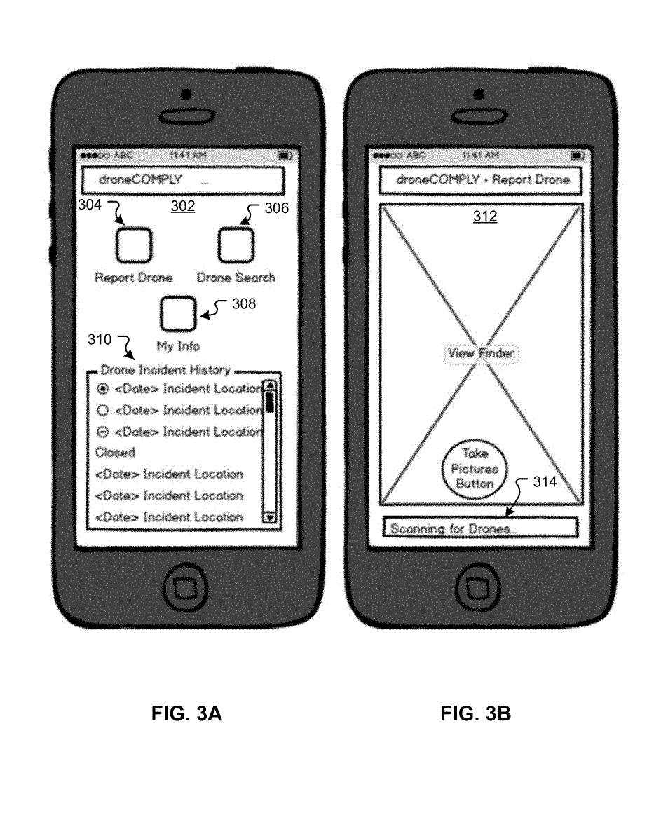

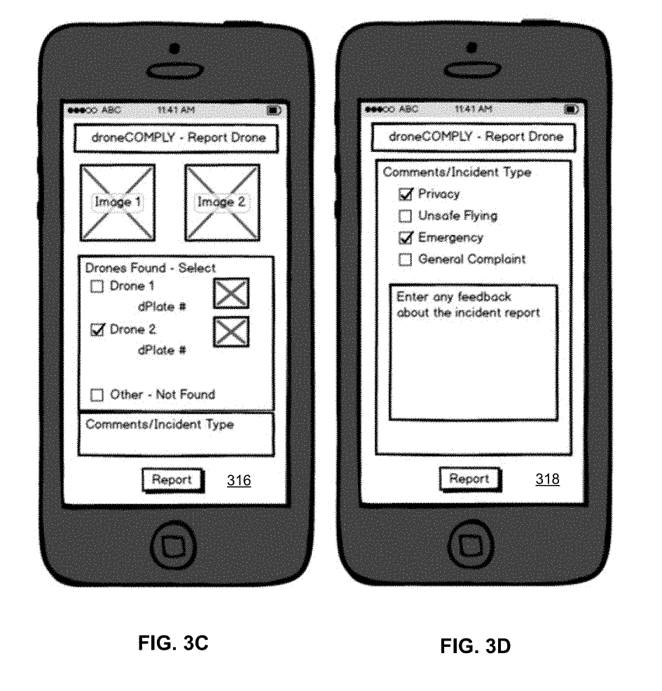

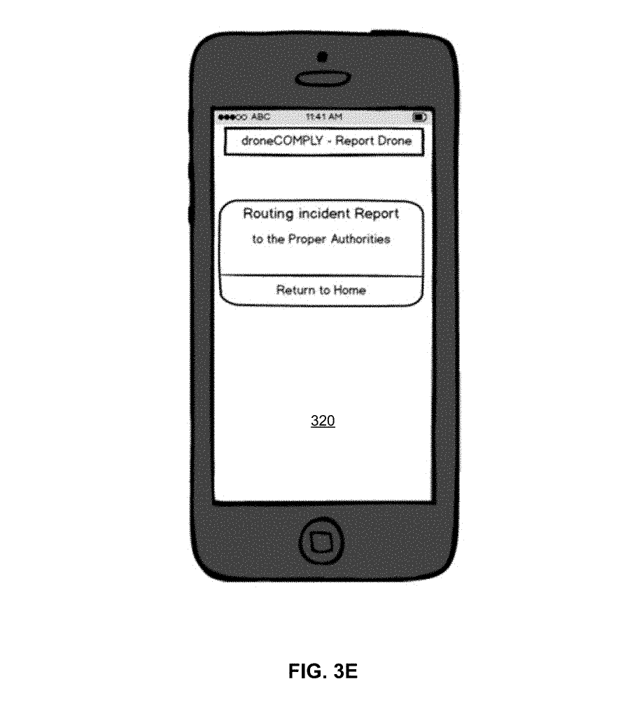

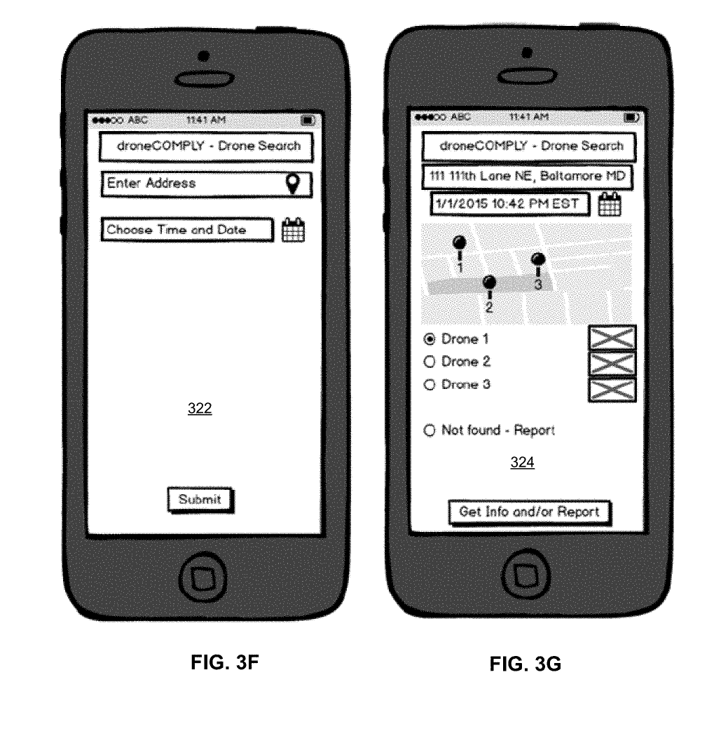

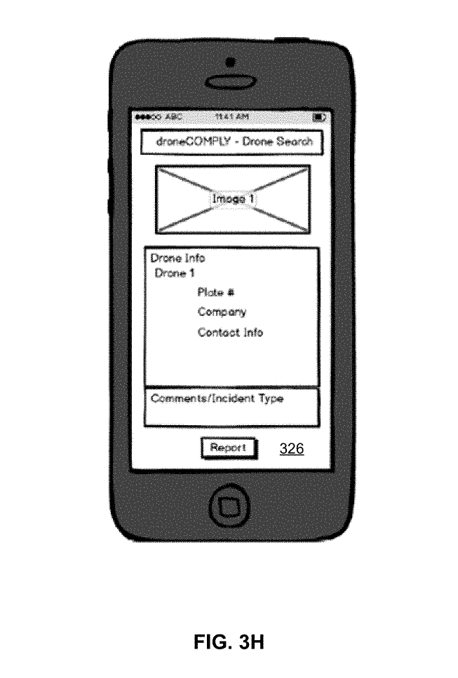

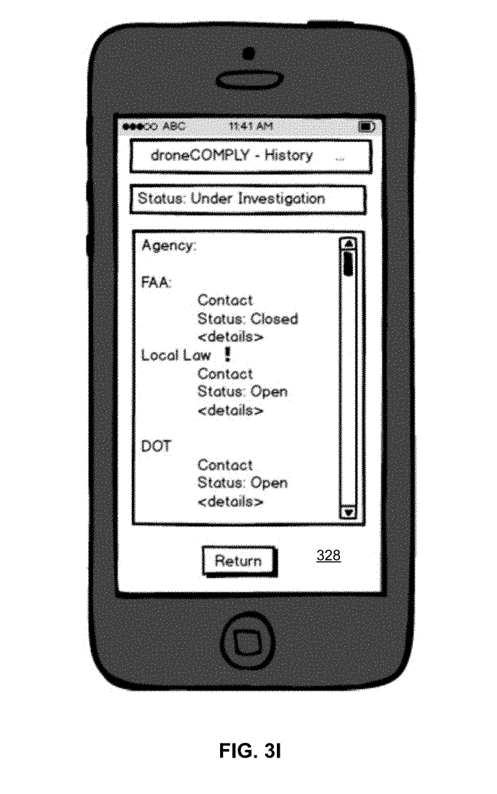

FIG. 3A illustrates an example Home Screen 302 of unmanned vehicle data collection and reporting application 118, in accordance with various embodiments of the present disclosure. Home Screen 302 may provide an option to search for unmanned vehicles and an option to report a unmanned vehicle. A user of unmanned vehicle data collection and reporting application 118 may select Report Drone button 304 to report an unmanned vehicle. A user may select Drone Search button 306 to search for an unmanned vehicle. In various examples, My Info button 308 may allow a user to store contact information for the user and various account settings. Drone Incident History Display 310 may display a list and/or a current status of various unmanned vehicle-related incidents reported by the user through unmanned vehicle data collection and reporting application 118.

FIG. 3B illustrates an Image and Video Capture Screen 312 of unmanned vehicle data collection and reporting application 118. In various examples, a user of unmanned vehicle data collection and reporting application 118 may be routed to Image and Video Capture Screen 312 upon selecting Report Drone button 304 from home screen 302. Image and Video Capture Screen 312 may use a camera of the device on which unmanned vehicle data collection and reporting application 118 is executing. For example, Image and Video Capture Screen 312 may use a smartphone camera to capture videos and/or photographs of unmanned vehicles when unmanned vehicle data collection and reporting application 118 is executing on the smartphone. As depicted in FIG. 3B a viewfinder may allow a user to properly frame a photograph and/or video of a unmanned vehicle. A “Take Pictures Button” may be used to capture the photograph and/or video. In various other embodiments, unmanned vehicle data collection and reporting application 118 may selectively capture audio signals transmitted or otherwise produced by unmanned vehicles. In some examples, audio signals may be used to help identify particular unmanned vehicles. Scanning for Drones Field 314 may activate a scan for unmanned vehicle data signals being broadcast from one or more unmanned vehicles in the surrounding vicinity, such as signal 116 broadcast from unmanned vehicle 102 (shown in FIG. 1). If an unmanned vehicle signal is detected, Scanning for Drones field 314 may transition to a “Next” button.

FIG. 3C illustrates a Reporting Screen 316 of a unmanned vehicle data collection and reporting application, in accordance with various embodiments of the present disclosure. Reporting Screen 316 may display one or more images captured by the user of unmanned vehicle data collection and reporting application 118 using Image and Video Capture Screen 312. Images may be selected and/or deselected for purposes of reporting. If unmanned vehicle identifying information is received via a signal broadcast from a unmanned vehicle and detected during a scan by unmanned vehicle data collection and reporting application 118, the unmanned vehicle identifying information may be displayed at Reporting Screen 316. In some examples, the unmanned vehicle identifying information may be referred to as a “digital license plate”, abbreviated as “dPlate #” in FIG. 3C. Unmanned vehicle identifying information may include various metadata, such as the unmanned vehicle data described above with respect to FIG. 1.

Additionally, a user may select “Other—Not Found” to indicate that the unmanned vehicle being reported has not been correctly identified by the user application 118. Reporting Screen 316 may include a field for a user to provide comments concerning a type of incident. Upon selection of the Comments/Incident Type field, unmanned vehicle data collection and reporting application 118 may transition from the Reporting Screen 316 depicted in FIG. 3C to the Reporting Screen 318 depicted in FIG. 3D. In some examples, the unmanned vehicle data collection and reporting application 118 may transition from Reporting Screen 316 to Reporting Screen 318 by zooming or panning out.

Reporting Screen 318 may provide options for a user to indicate a type of unmanned vehicle incident witnessed by the user. For example, the user may be concerned because the unmanned vehicle is flying over the user's private property and appears to have a camera attached to the unmanned vehicle. The user may select “Privacy” to indicate that the user's privacy is being impinged upon. In some examples, unmanned vehicle data collection and reporting application 118 may allow a user to denote areas of private property or prohibited unmanned vehicle operation zones. For example, a user may indicate a geo-fence surrounding private property owned by the user within unmanned vehicle data collection and reporting application 118. Thereafter, the geo-fence and/or restrictions on unmanned vehicle operation within the geo-fence may be submitted to unmanned vehicle data service 120 to share with unmanned vehicle owners, operators, and/or regulatory bodies. Various other incident types may be indicated on reporting screen 318. Incident types may include unsafe flying, emergencies, and/or general complaint. A field may be provided for the user to provide more detail concerning the type of incident and/or identifying characteristics of the unmanned vehicle. The “Report” button on Reporting Screen 316 and Reporting Screen 318 may submit the incident report to unmanned vehicle data service 120 (shown in FIG. 1). In response, unmanned vehicle data service 120 may parse and correlate unmanned vehicle data associated with the user submission and may compare the data to applicable regulations and may report the unmanned vehicle incident to the appropriate entities, as described above in reference to FIG. 1. Upon selection of the Report button, unmanned vehicle data collection and reporting application 118 may transition to Reporting Confirmation Screen 320 depicted in FIG. 3E.

Referring to Home Screen 302 depicted in FIG. 3A, upon selection of Drone Search button 308, unmanned vehicle data collection and reporting application 118 may transition from Home Screen 302 to Unmanned vehicle Search Screen 322 depicted in FIG. 3F. On Unmanned vehicle Search Screen 322, the user may select an address or may use the user's current location and may indicate a particular date and time or may choose a range of times and dates to search for unmanned vehicle activity near the selected location and within the selected time frame. A user may select the Submit button to perform the search. Upon selection of the submit button unmanned vehicle data collection and reporting application 118 may transition from Unmanned vehicle Search Screen 322 to Unmanned vehicle Search Results Screen 324 depicted in FIG. 3G.

Unmanned vehicle Search Results Screen 324 may show the address selected on Unmanned vehicle Search Screen 322 and may show unmanned vehicle activity near the selected address or location and within the specified time frame. For example, unmanned vehicle data collection and reporting application 118 may search computer readable memory 140 of unmanned vehicle data service 120 and/or may search one or more third party databases to identify unmanned vehicles and unmanned vehicle activity near the selected address or location. Indications of unmanned vehicle identity (depicted as “Drone 1”, “Drone 2”, and “Drone 3” in FIG. 3G) may be provided along with images of the unmanned vehicles, if available. A user may select a particular unmanned vehicle and may select a “Get Info and/or Report” button to get further information regarding the selected unmanned vehicle. Additionally, a user may determine that the unmanned vehicles returned by the Unmanned vehicle Search Results Screen 324 do not correspond to the particular unmanned vehicle in which the user is interested. Upon selection of the Get Info and/or Report button, unmanned vehicle data collection and reporting application 118 may transition from Unmanned vehicle Search Results Screen 324 to Unmanned vehicle Information Screen 326 depicted in FIG. 3H.

Unmanned vehicle Information Screen 326 depicted in FIG. 3H may display one or more images of the particular unmanned vehicle selected in Unmanned vehicle Search Results Screen 324. Additionally, Unmanned vehicle Information Screen 326 may display data related to the selected unmanned vehicle. For example, a registration #, plate #, affiliated company, pilot name, contact info, unmanned vehicle type, etc. may be displayed. Other types of unmanned vehicle data and metadata may be displayed and/or may be associated with the unmanned vehicle by unmanned vehicle data collection and reporting application 118, but not displayed on Unmanned vehicle Information Screen 326. For example, unmanned vehicle velocity information, heading information, etc. may be associated with the selected unmanned vehicle. A Comments/Incident Type field may be selected by the user in order to transition from Unmanned vehicle Information Screen 326 to Reporting Screen 318 depicted in FIG. 3D. A user may select the Report button on Reporting Screen 318 or on Unmanned vehicle Information Screen 326 to submit the incident report to unmanned vehicle data service 120 (shown in FIG. 1).

Referring to Home Screen 302 depicted in FIG. 3A, upon selection of a particular unmanned vehicle incident in Drone Incident History Display 310, unmanned vehicle data collection and reporting application 118 may transition from Home Screen 302 to Submitted Incident Status Screen 328 depicted in FIG. 3I. Submitted Incident Status Screen 328 may display information regarding actions taken by one or more entities in response to the incident. Additionally, status information, such as whether the investigation is on-going or whether the particular entity considers the investigation to be closed may be displayed. A user may click on a particular investigation conducted by a particular entity to receive more detail concerning the investigation. In some examples, detail may be provided by unmanned vehicle data service 120 through communication with the particular entity selected.

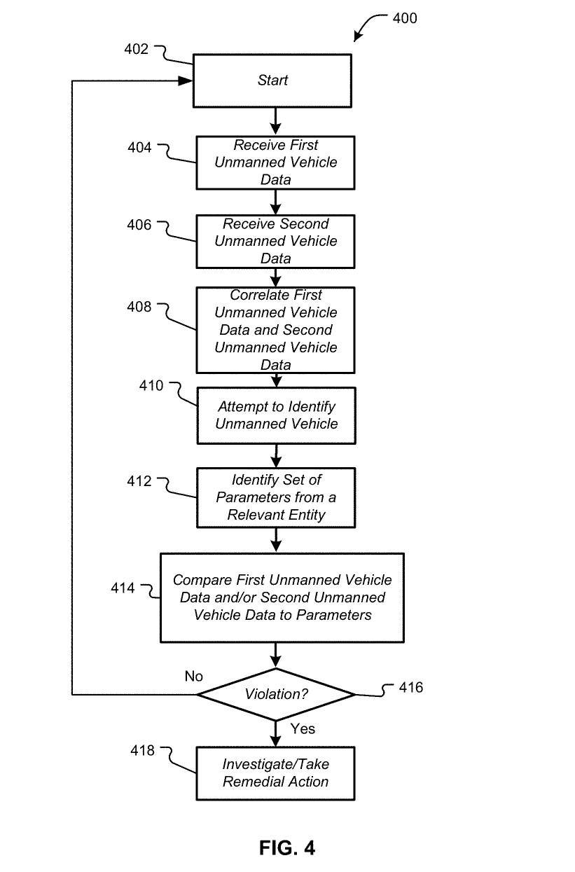

FIG. 4 depicts a process flow 400 for processing unmanned vehicle data received by unmanned vehicle data service 120, in accordance with various aspects of the present disclosure. Those portions of FIG. 4 that have been described previously with respect to FIGS. 1-3 may not be described again herein, for purposes of clarity and brevity.

In various examples, the at least one processor 130 of unmanned vehicle data service 120, depicted in FIG. 1, may be effective to carry out one or more of the actions described in the flow chart shown in FIG. 4. Processing may begin at action 402, “Start”. Processing may proceed from action 402 to action 404, “Receive First Unmanned vehicle Data”. At action 404 unmanned vehicle data service 120 may receive first unmanned vehicle data. In various examples, first unmanned vehicle data may include various information about a unmanned vehicle, such as unmanned vehicle 102 depicted in FIG. 1. In a few examples, unmanned vehicle data may include unmanned vehicle position information, unmanned vehicle identifying information, unmanned vehicle ownership information, and the like. Unmanned vehicle data service 120 may be effective to queue and route the first unmanned vehicle data received at action 404 in real time to appropriate networked storage locations, such as within various data repositories in computer readable memory 140.

First unmanned vehicle data received at action 404 may be received from various sources. For example, the first unmanned vehicle data may be received from unmanned vehicle data collection and reporting application 118. In another example, unmanned vehicle data may be received from a third party data base, such as a DJI database that stores unmanned vehicle information and/or an FAA unmanned vehicle registration database.

Processing may proceed from action 404 to action 406, “Receive Second Unmanned vehicle Data”. At action 406, unmanned vehicle data service 120 may receive second unmanned vehicle data. In various examples, second unmanned vehicle data may include various information about a unmanned vehicle, such as unmanned vehicle 102 depicted in FIG. 1 or about a different unmanned vehicle. Second unmanned vehicle data may include any information about a unmanned vehicle including identifying information, metadata related to unmanned vehicle position, speed, operator information, ownership information, etc. Second unmanned vehicle data may be received from any source, including the various sources described above in reference to action 402.

Processing may proceed from action 406 to action 408, “Correlate First Unmanned vehicle Data and Second Unmanned vehicle Data”. At action 408, first unmanned vehicle data and second unmanned vehicle data may be correlated with information stored in one or more databases of unmanned vehicle data service 120. In an example, the first unmanned vehicle data received at action 404 may have been received from a user via unmanned vehicle data collection and reporting application 118. The first unmanned vehicle data may include a geotagged and time-stamped photograph of the unmanned vehicle at issue. The coordinates from the geotag may be compared with information regarding unmanned vehicle operation within a certain radius of the longitude and latitude indicated by the geotag and within a particular time differential of the time-stamp (e.g., +/−5 seconds, 15 seconds, 2 minutes, 10 minutes, etc.). In the example, unmanned vehicle data service 120 may determine that a particular unmanned vehicle was located 50 meters due west of the geotag coordinates 20 seconds prior to the time indicated by the time stamp of the user photograph. Additionally, the second unmanned vehicle data may include information from a third party database indicating that a unmanned vehicle was located at a position 25 meters due west of the first data's geotag coordinates 10 seconds prior to the time indicated by the time stamp in the first unmanned vehicle data and that the unmanned vehicle was headed due east at a velocity of 2.5 meters per second. Based on the correlation between the first unmanned vehicle data, the second unmanned vehicle data, and other unmanned vehicle data accessible by unmanned vehicle data service 120, unmanned vehicle data service may determine a correlation between the first unmanned vehicle data and the second unmanned vehicle data.

Processing may proceed from action 408 to action 410, “Attempt to Identify Unmanned vehicle”. At action 410, unmanned vehicle data service 120 may determine whether or not the first unmanned vehicle data and/or the second unmanned vehicle data can be matched to accessible unmanned vehicle identifying information. For example, the first unmanned vehicle data may be matched to a particular unmanned vehicle identification number stored in computer readable memory 140 or in another memory accessible by unmanned vehicle data service 120. In some examples, the first data may be matched to the particular unmanned vehicle identification number based on correlations formed at action 408. In another example, the second unmanned vehicle data may be matched to a different unmanned vehicle identification number stored in a memory accessible by unmanned vehicle data service 120. In another example, the first unmanned vehicle data may be matched to a first unmanned vehicle registration number. The second unmanned vehicle data may be matched to the first unmanned vehicle registration number based on a determination that the first unmanned vehicle data and the second unmanned vehicle data relate to operation of the same unmanned vehicle. Such determinations may be made based on latitude and longitude data, heading data, unmanned vehicle identifying data, velocity data, acceleration data, altitude data, time data, visual data, etc.

In an example, unmanned vehicle data service 120 may receive information related to a particular unmanned vehicle from a user's mobile device. In the example, the information may include GPS data and time stamp data related to a unmanned vehicle incident. The GPS data may identify a location of a unmanned vehicle and/or the location of the mobile device when reporting the unmanned vehicle incident or capturing an image and/or video of the unmanned vehicle. The time stamp may indicate a time at which a video and/or image was captured or may be the time at which the unmanned vehicle incident was reported to unmanned vehicle data service 120. Unmanned vehicle data service 120 may search for other unmanned vehicle data that is within a threshold distance of the location indicated by the GPS data (e.g., within 50 meters, 100 meters, 300 meters, 1 mile, 5 miles, etc.). In some examples, unmanned vehicle data service 120 may expand the search by increasing the threshold distance if no results are initially found. Similarly, unmanned vehicle data service 120 may search for unmanned vehicle data indicating other unmanned vehicle incidents which occurred and/or were reported within a threshold amount of time of the time indicated by the time stamp (e.g. +/−1 minute, 2 minutes, 500 seconds, 10 minutes, 1 hour, 1 day, etc.). If one or more likely matches are found, unmanned vehicle data service 120 may a list of the likely matches (including images and/or data regarding the matched unmanned vehicle or unmanned vehicles) to the user through unmanned vehicle data collection and reporting application 118 for confirmation and/or verification. Other information may be used to match unmanned vehicle incidents to particular unmanned vehicles together with and separately from time stamp data and GPS data. In some non-exhaustive examples, altitude, heading, flight path, velocity, acceleration, or the like may be used to identify correlations between unmanned vehicle incidents and potentially identify unmanned vehicles that are the subjects of one or more incident reports.

If the unmanned vehicle cannot be matched to an existing unmanned vehicle identification number (or other unmanned vehicle identifying data), a new unmanned vehicle identifier may be created, associated with known data related to the unidentified unmanned vehicle, and stored in computer readable memory 140.

Processing may proceed from action 410 to action 412, “Identify Set of Parameters from a Relevant Entity.” At action 412, a set of parameters may be identified based on received unmanned vehicle data. In some examples, a first set of parameters may be identified based on the first unmanned vehicle data and a second set of parameters may be identified based on the second unmanned vehicle data. In some other examples, the same set of parameters may apply to both the first and second unmanned vehicle data. For example, if the first unmanned vehicle data and the second unmanned vehicle data are determined at actions 408 and 410 to relate to the same unmanned vehicle, the set of parameters may be based on both the first data and the second data.

In an example, the first unmanned vehicle data and the second unmanned vehicle data may be determined at actions 408 and 410 to relate to the same unmanned vehicle. Furthermore, the first unmanned vehicle data and second unmanned vehicle data may indicate that the unmanned vehicle at a time t₁ was located in a first county and the second unmanned vehicle data may indicate that at a time t₂ the unmanned vehicle had crossed county lines and was located in a second county. Each of the first and second counties may have different rules and laws governing unmanned vehicle operation. For example, in the first county it may be illegal to operate a unmanned vehicle at an altitude above 375 feet. The second county, by contrast, may have a rule prohibiting unmanned vehicle operation above 400 feet. The sets of rules, laws, and regulations applicable to each county may be identified as parameters in the set of parameters identified at action 412. The parameters may be stored in computer readable memory 140 and/or may be provided by various governmental entities, such as by law enforcement agencies 122 and/or governmental entities 124 (depicted in FIG. 1).

Processing may proceed from action 412 to action 414, “Compare First Unmanned vehicle Data and/or Second Unmanned vehicle Data to Parameters.” At action 414, the first unmanned vehicle data and/or second unmanned vehicle data may be applied to applicable parameters. To continue the example above, altitude information may indicate that at time t₁, in the first county, and at time t₂, in the second county, the unmanned vehicle was flying at an altitude of 390 feet. Unmanned vehicle data service 120 may compare the altitude of the unmanned vehicle to the applicable regulation based on the location of the unmanned vehicle, the unmanned vehicle's altitude and the controlling regulations for the particular unmanned vehicle location.

Processing may proceed from action 414 to action 414, “Violation?” At action 414, unmanned vehicle data service may determine whether or not the reported unmanned vehicle incident violates one or more of the parameters identified at action 412. In the example, it may be determined that the particular unmanned vehicle incident violated the maximum flying altitude regulation of the first county, but did not violate the maximum flying altitude regulation of the second county. The maximum altitude regulation is given for exemplary purposes. Various other parameters are intended based on public regulations at the municipal, county, state, and federal levels and/or based on private regulations and/or by-laws. Parameters may be updated as laws related to unmanned vehicle operation change, are enacted and/or are invalidated or repealed. If no violation is detected, processing may return to the start of process flow 400 to gather more unmanned vehicle data.

If a violation is detected, processing may proceed from action 416 to action 418, “Investigate/Take Remedial Action”. At action 418, an indication of the violation of one or more parameters may be provided to the appropriate entity, such as the applicable law enforcement agencies 122 and/or governmental entities 124. Additionally, a log of the violation may be stored in computer readable memory 140 in association with whatever data is known about the incident and the particular unmanned vehicle or unmanned vehicles involved. In various examples, an indication of the severity of the violation or of the incident may be determined. In the event of a high-risk emergency, unmanned vehicle data service 120 may send an alert to one or more emergency agencies in addition to the normal violation reporting procedure. Additionally, unmanned vehicle data service 120 may update a status of the incident and may provide status updates to one or more users reporting the incident.

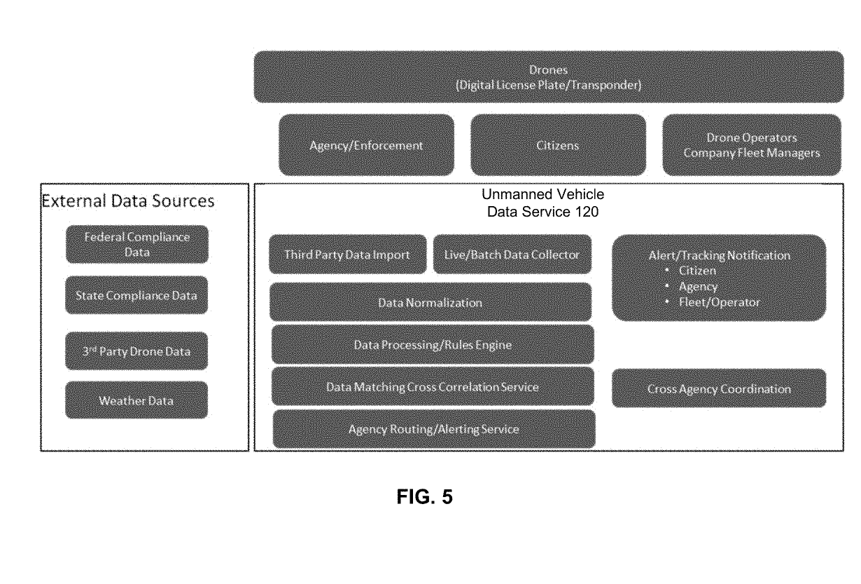

FIG. 5 depicts an example system for collecting and processing unmanned vehicle data, in accordance with embodiments of the present disclosure. Unmanned vehicles such as drones may send unmanned vehicle data, such as a digital identifier—sometimes referred to as a “license plate”, or other characteristic data from a transponder or transceiver. Unmanned vehicle data service 120 may receive data transmitted from drones. Additionally, in other examples, unmanned vehicle data may not be transmitted from the drone, but may instead be captured, identified, and/or reported by a regulatory and/or enforcement agency, citizens, and/or by drone operators and company fleet managers. Unmanned vehicle data captured or otherwise identified by agencies, citizens and/or operators may be transmitted through a computing device to unmanned vehicle data service 120. For example, a citizen may send unmanned vehicle data to unmanned vehicle data service 120 through unmanned vehicle data collection and reporting application 118, as discussed previously.

Unmanned vehicle data service 120 may be a distributed computing system, or “cloud” computing system and may also receive data from other external sources apart from those described above. For example, unmanned vehicle data service 120 may be informed by data received from federal compliance databases, state compliance databases, third party drone databases (e.g., a DJI database), local, regional, or national weather services, etc.

Unmanned vehicle data service 120 may receive data as a live stream or in batches. Additionally, unmanned vehicle data service 120 may periodically update databases based on updates from third party data sources, such as when new regulations are promulgated and/or updated compliance data is released. Data received by unmanned vehicle data service 120 may be normalized and processed. As described above, rules may be applied to normalized unmanned vehicle data and third party data. Data matching and correlations may be performed on unmanned vehicle data and third party data received by unmanned vehicle data service 120. Correlations between data received by unmanned vehicle data service 120 may allow unmanned vehicles to be identified and/or tracked. Further, the rules engine of unmanned vehicle data service 120 may compare unmanned vehicle data to applicable rules and regulations to determine violations and/or to provide an overview of unmanned vehicle activity to citizens, agencies, and/or fleet managers. Cross correlation service and rules engine may allow for unmanned vehicle data to be properly triaged and routed to one or more agencies, as appropriate, allowing for cross agency coordination. Additionally, as described previously, unmanned vehicle data service 120 may provide alerts and/or status updates through unmanned vehicle data collection and reporting application 118 or through a web portal. For example, dangerous drone activity may be reported to a law enforcement agency through a designated and authenticated law enforcement web portal. In another example, a status update on the disposition of a drone incident may be sent to a user through unmanned vehicle data collection and reporting application 118 in order to update the citizen user on the status of a drone incident reported by that user.

Among other potential benefits, a system in accordance with the present disclosure may allow citizens to report non-compliant, illegal, and/or suspicious unmanned vehicle activity to a centralized repository through a convenient interface of a user application. A cloud data processing system may process large volumes of data received from the user applications as well as from third party databases to correlate information regarding unmanned vehicle incidents to both identify unmanned vehicles and, when appropriate, report unmanned vehicle activity to the applicable regulatory and/or law enforcement agencies. The cloud data processing system may be effective to provide feedback regarding an on-going incident report to the user generating the report through the user application. In some examples, the cloud data processing system may solicit further user feedback in order to identify a particular unmanned vehicle related to an incident. For example, the cloud data processing system may send image data showing three different models of a unmanned vehicle that have been determined by the cloud data processing system as having the highest likelihood of being the unmanned vehicle involved in the user-reported incident. If the user recognizes an image of the unmanned vehicle involved in the incident reported by the user, the user may report the same to the cloud data processing system. The cloud data processing system may be integrated with systems of regulatory and/or law enforcement agencies to allow for cooperative efforts for on-going monitoring and policing of unmanned vehicle activity.

While the invention has been described in terms of particular embodiments and illustrative figures, those of ordinary skill in the art will recognize that the invention is not limited to the embodiments or figures described. For example, databases associated with unmanned vehicle data service 120 may include interfaces for law enforcement agencies to actively monitor unmanned vehicle activity in a particular locale.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

Specific elements of any embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A computer-implemented method of processing unmanned vehicle data, the method comprising:
receiving first unmanned vehicle data related to a first unmanned vehicle from a first computing device;
receiving second unmanned vehicle data related to the first unmanned vehicle from a second computing device;
determining that the first unmanned vehicle data and the second unmanned vehicle data relate to the first unmanned vehicle;
identifying a parameter from a governmental entity, wherein the parameter defines an operating limitation for unmanned vehicles;
comparing at least one of the first unmanned vehicle data and the second unmanned vehicle data to the parameter; and
determining that the first unmanned vehicle has operated in violation of the operating limitation.

2. The computer-implemented method of claim 1, further comprising:
transmitting an indication that the first unmanned vehicle has operated in violation of the operating limitation to the governmental entity.

3. The computer-implemented method of claim 2, further comprising:
providing a status update to a user interface of an unmanned vehicle data collection and reporting application, wherein the status update is related to actions taken by the governmental entity in response to the indication that the first unmanned vehicle has operated in violation of the operating limitation.

4. The computer-implemented method of claim 1, further comprising:
receiving unmanned vehicle position data related to a second unmanned vehicle;
comparing the unmanned vehicle position data to other unmanned vehicle position data stored in a networked database;
identifying a correlation between the unmanned vehicle position data and at least a portion of the other unmanned vehicle position data;
identifying a unmanned vehicle identity associated with the portion of the other unmanned vehicle position data; and
associating the second unmanned vehicle with the unmanned vehicle identity.

5. The computer-implemented method of claim 1, wherein the first unmanned vehicle data includes photograph data, audio data, or video data representing the first unmanned vehicle and position data associated with the first computing device at the time the photograph data, audio data, or video data was captured.

6. The computer-implemented method of claim 1, further comprising:
transmitting, by the first unmanned vehicle, the first unmanned vehicle data, wherein the first unmanned vehicle data includes an indication of an identity of the first unmanned vehicle; and
prior to receiving the first unmanned vehicle data from the first computing device, receiving, by the first computing device, the first unmanned vehicle data from the first unmanned vehicle.

7. The computer-implemented method of claim 1, where determining that the first unmanned vehicle data and the second unmanned vehicle data relate to the first unmanned vehicle comprises identifying a correspondence between first unmanned vehicle metadata of the first unmanned vehicle data and second unmanned vehicle metadata of the second unmanned vehicle data.

8. The computer-implemented method of claim 7, wherein the first unmanned vehicle metadata and the second unmanned vehicle metadata include at least one of unmanned vehicle longitude information, unmanned vehicle latitude information, and unmanned vehicle altitude information.

9. The computer-implemented method of claim 8, wherein the first unmanned vehicle metadata and the second unmanned vehicle metadata further includes one or more time stamps.

10. The computer-implemented method of claim 1, wherein the parameter relates to a regulation or law applicable to unmanned vehicle operation in a location where the first unmanned vehicle was operating at the time the first unmanned vehicle data was generated.

11. The computer-implemented method of claim 1, wherein comparing at least one of the first unmanned vehicle data and the second unmanned vehicle data to the parameter comprises comparing a value related to a state of operation of the first unmanned vehicle indicated by at least one of the first unmanned vehicle data and the second unmanned vehicle data to a threshold value of a permissible state of operation for the first unmanned vehicle defined by the parameter.

12. A unmanned vehicle data processing computing device, comprising:
at least one processor; and
a non-transitory, computer-readable memory configured to be in communication with the at least one processor;
the at least one processor effective to:
receive first unmanned vehicle data related to an unmanned vehicle from a first computing device;
receive second unmanned vehicle data related to the unmanned vehicle from a second computing device;
determine that the first unmanned vehicle data and the second unmanned vehicle data relate to the unmanned vehicle by correlating first metadata of the first unmanned vehicle data with second metadata of the second unmanned vehicle data;
identify a parameter stored in the computer-readable memory, wherein the parameter defines an operating limitation for unmanned vehicles;
compare at least one of the first unmanned vehicle data and the second unmanned vehicle data to the parameter; and
determine that the unmanned vehicle has operated in violation of the operating limitation.

13. The server of claim 12, wherein the at least one processor is further effective to transmit an indication that the unmanned vehicle has operated in violation of the operating limitation to a governmental entity.

14. The server of claim 13, wherein the at least one processor is further effective to provide a status update to a user interface of a unmanned vehicle data collection and reporting application, wherein the status update is related to actions taken by the governmental entity in response to the indication that the first unmanned vehicle has operated in violation of the operating limitation.

15. The server of claim 12, wherein the at least one processor is further effective to:
receive unmanned vehicle position data related to a second unmanned vehicle;
compare the unmanned vehicle position data to other unmanned vehicle position data stored in the computer-readable memory;
identify a correlation between the unmanned vehicle position data and at least a portion of the other unmanned vehicle position data;
identify a unmanned vehicle identity associated with the portion of the other unmanned vehicle position data; and
associate the second unmanned vehicle with the unmanned vehicle identity.

16. The server of claim 12, wherein the first unmanned vehicle data includes photograph data or video data representing the first unmanned vehicle and position data associated with the first computing device at the time the photograph data or video data were captured.

17. There server of claim 12, wherein the parameter relates to a regulation or law applicable to unmanned vehicle operation in a location where the first unmanned vehicle was operating at the time the first unmanned vehicle data was generated.

18. A computer-implemented method to identify a unmanned vehicle, the method comprising:
receiving location data and time stamp data from a mobile computing device as a part of a unmanned vehicle incident report, wherein the location data indicates a location and wherein the time stamp data indicates a time;
searching a database using the location data and the time stamp data as a search query to the database;
receiving a first list of reported unmanned vehicle incidents, wherein the reported unmanned vehicle incidents occurred within a threshold distance of the location and within a threshold amount of time of the time indicated by the time stamp data;
identifying a second list of one or more unmanned vehicles involved in the first list of reported unmanned vehicle incidents; and
sending the second list of the one or more unmanned vehicles to the mobile computing device or another computing device.

19. The method of claim 18, further comprising:
displaying images of the one or more unmanned vehicles at the mobile computing device;
receiving a selection of a first unmanned vehicle of the one or more unmanned vehicles at the mobile computing device, wherein the selection indicates that the first unmanned vehicle was involved in a unmanned vehicle incident for which the unmanned vehicle incident report was generated; and
storing an association between the first unmanned vehicle and the unmanned vehicle incident report in the database.

20. The method of claim 19, further comprising sending the unmanned vehicle incident report and data identifying the first unmanned vehicle to a governmental entity.
